(19) United States
(12) Patent Application Publication
(10) Pub. No.: US 2016/0157079 A1
(43) Pub. Date: Jun. 2, 2016

(54) USER TERMINAL, NETWORK APPARATUS, AND PROCESSOR

(71) Applicant: KYOCERA CORPORATION, Kyoto (JP)

(72) Inventors: Takahiro SAIWAI, Kawasaki-shi, Kanagawa (JP); Kugo MORITA, Yokohama-shi, Kanagawa (JP)

(73) Assignee: KYOCERA CORPORATION, Kyoto (JP)

(21) Appl. No.: 14/903,441

(22) PCT Filed: Jul. 8, 2014
(86) PCT No.: PCT/JP2014/068151

§ 371 Date: Jan. 7, 2016

(30) Foreign Application Priority Data
Jul. 9, 2013 (JP) 2013-144027

(51) Int. Cl. H04W 8/00; H04W 76/02; H04W 72/08

(52) U.S. Cl. CPC H04W 8/005; H04W 72/082; H04W 76/023

(57) ABSTRACT

eNB 200 performs control on UE 100 that transmits or receives the periodical discovery signal by using the first radio resource. The eNB 200 notifies the UE 100 of a second radio resource for transmitting or receiving the non-periodical discovery signal between the UE 100 and a different UE 100 associated with the UE 100. The UE 100 uses the second radio resource to transmit or receive the non-periodical discovery signal.

### TECHNICAL FIELD

The present invention relates to a user terminal in a mobile communication system that supports D2D communication, a network apparatus thereof, and a processor thereof.

### BACKGROUND ART

In 3GPP (3rd Generation Partnership Project) which is a project aiming to standardize a mobile communication system, the introduction of Device-to-Device (D2D) communication is discussed as a new function after Release 12 (see Non Patent Literature 1).

In the D2D communication, a plurality of nearby user terminals perform direct device-to-device communication without passing through a network. On the other hand, in cellular communication which is normal communication in a mobile communication system, a user terminal performs communication through a network. When the D2D communication is utilized, it is possible to improve a performance of the mobile communication system.

### CITATION LIST

### Non Patent Literature

[NPL 1] 3GPP Technical Report “TR 22.803 V12.1.0” March 2013

### SUMMARY OF INVENTION

A user terminal periodically transmits or receives a discovery signal used for discovering a nearby user terminal to perform D2D communication. After such a discovery process, the user terminal performs the D2D communication with the nearby user terminal.

However, the user terminal transmits or receives a discovery signal only during a predetermined period, and thus, even when there is a nearby user terminal with which the D2D communication should be performed, it is difficult to promptly start the D2D communication. On the other hand, it may be possible to adopt a method in which a period during which the discovery signal is transmitted or received is previously set short; however, there is a problem that a consumption amount of radio resources to be used for transmitting or receiving the discovery signal increases, resulting in a lowered utilization efficiency of the radio resource.

Therefore, it is an object of the present invention to provide a user terminal, a network apparatus, and a processor, with which it is possible to restrain lowering of a utilization efficiency of a radio resource and promptly start D2D communication.

### Means for Solving the Problem

A user terminal according to a first aspect transmits or receives a discovery signal for D2D communication that is direct Device-to-Device communication in a mobile communication system supporting the D2D communication. The user terminal comprises a controller configured to transmit or receive a periodical discovery signal by using a first radio resource recognized by all user terminals in a predetermined area of the mobile communication system. The controller further transmits or receives a non-periodical discovery signal by using a second radio resource recognized by the user terminal and a different user terminal associated with the user terminal.

A network apparatus according to a second aspect is included in a network of a mobile communication system that supporting D2D communication that is direct Device-to-Device communication. The network apparatus comprises a controller configured to perform control on a user terminal that transmits or receives a periodical discovery signal by using a first radio resource recognized by all user terminals in a predetermined area of the mobile communication system. The controller notifies the user terminal of a second radio resource for transmitting or receiving a non-periodical discovery signal between the user terminal and a different user terminal associated with the user terminal.

A processor according to a third aspect is provided in a user terminal that transmits or receives a discovery signal for D2D communication that is direct Device-to-Device communication, in a mobile communication system supporting the D2D communication. The processor executes a process of transmitting or receiving a periodical discovery signal by using a first radio resource recognized by all user terminals in a predetermined area of the mobile communication system; and a process of transmitting or receiving a non-periodical discovery signal by using a second radio resource recognized by the user terminal and a different user terminal associated with the user terminal.

### BRIEF DESCRIPTION OF DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram of a radio interface according to the embodiment.

FIG. 5 is a configuration diagram of a radio frame according to the embodiment.

FIG. 6 is a diagram for describing D2D communication according to the embodiment.

FIG. 7 is a diagram for describing an operation pattern 1 according to the embodiment.

FIG. 8 is a diagram for describing an operation pattern 2 according to the embodiment.

FIG. 9 is a diagram for describing an operation pattern 3 according to the embodiment.

FIG. 10 is a sequence diagram of the operation pattern 1 according to the embodiment.

FIG. 11 is a sequence diagram of a case where interference is avoided led by the UE in the operation pattern 2 according to the embodiment.

FIG. 12 is a sequence diagram of the operation pattern 3 according to the embodiment.

FIG. 13 is a sequence diagram according to a first modification of the embodiment.

FIG. 14 is a flow diagram showing a connection determination operation according to a second modification of the embodiment.

FIG. 15 is a diagram for describing resource division according to the second modification of the embodiment.

### DESCRIPTION OF EMBODIMENTS

### Overview of Embodiment

A user terminal according to embodiments transmits or receives a discovery signal for D2D communication that is direct Device-to-Device communication in a mobile communication system supporting the D2D communication. The user terminal comprises a controller configured to transmit or receive a periodical discovery signal by using a first radio resource recognized by all user terminals in a predetermined area of the mobile communication system. The controller further transmits or receives a non-periodical discovery signal by using a second radio resource recognized by the user terminal and a different user terminal associated with the user terminal.

In the embodiments, the second radio resource is notified from a network apparatus included in a network of the mobile communication system. The controller transmits or receives the non-periodical discovery signal by using the second radio resource notified from the network apparatus.

In the embodiments, the different user terminal associated with the user terminal is a user terminal determined to be near the user terminal.

In the embodiments, the different user terminal associated with the user terminal is a user terminal that performs cellular communication with the user terminal via a network of the mobile communication system.

In the embodiments, the different user terminal associated with the user terminal is a user terminal determined to apply interference to the user terminal and/or to receive interference from the user terminal.

In the embodiments, out of the user terminal and the different user terminal associated with the user terminal, one user terminal is a user terminal that performs the D2D communication and another user terminal is a user terminal that desires to start communication with the one user terminal.

A network apparatus according to the embodiments is included in a network of a mobile communication system that supporting D2D communication that is direct Device-to-Device communication. The network apparatus comprises a controller configured to perform control on a user terminal that transmits or receives a periodical discovery signal by using a first radio resource recognized by all user terminals in a predetermined area of the mobile communication system. The controller notifies the user terminal of a second radio resource for transmitting or receiving a non-periodical discovery signal between the user terminal and a different user terminal associated with the user terminal.

In the embodiments, the different user terminal associated with the user terminal is a user terminal determined to be near the user terminal.

In the embodiments, the different user terminal associated with the user terminal is a user terminal that performs cellular communication with the user terminal via the network.

In the embodiments, the different user terminal associated with the user terminal is a user terminal determined to apply interference to the user terminal and/or to receive interference from the user terminal.

In the embodiments, out of the user terminal and the different user terminal associated with the user terminal, one user terminal is a user terminal that performs the D2D communication and another user terminal is a user terminal that desires to start communication with the one user terminal.

In the embodiments, when it is determined that performing the D2D communication between the user terminal and the different user terminal associated with the user terminal is disabled, the controller controls so that a data transmission-use radio resource assigned to the user terminal and a data transmission-use radio resource assigned to the different user terminal associated with the user terminal are differed.

A processor according to the embodiments is provided in a user terminal that transmits or receives a discovery signal for D2D communication that is direct Device-to-Device communication, in a mobile communication system supporting the D2D communication. The processor executes a process of transmitting or receiving a periodical discovery signal by using a first radio resource recognized by all user terminals in a predetermined area of the mobile communication system; and a process of transmitting or receiving a non-periodical discovery signal by using a second radio resource recognized by the user terminal and a different user terminal associated with the user terminal.

### Embodiment

An embodiment in which the present invention is applied to an LTE system will be described, below.

(System Configuration)

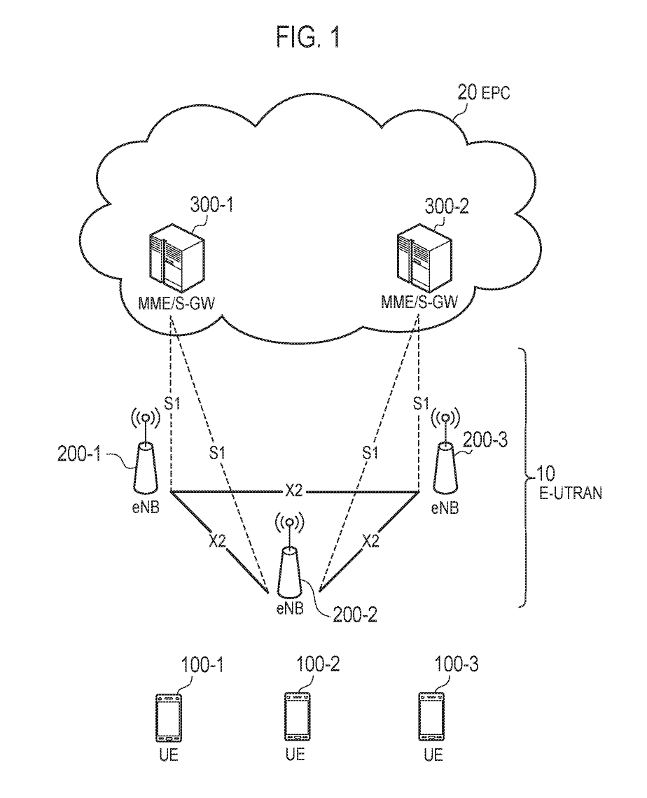

FIG. 1 is a configuration diagram of the LTE system according to the embodiment. As shown in FIG. 1, the LTE system according to the embodiment includes a UE (User Equipment) 100, an E-UTRAN (Evolved-UMTS Terrestrial Radio Access Network) 10, and an EPC (Evolved Packet Core) 20.

The UE 100 corresponds to a user terminal. The UE 100 is a mobile communication device, which performs radio communication with a cell (serving cell) with which connection is established. The configuration of the UE 100 will be described later.

The E-UTRAN 10 corresponds to a radio access network. The E-UTRAN 10 includes an eNB 200 (evolved Node-B). The eNB 200 corresponds to a base station. The eNBs 200 are connected mutually via an X2 interface. The configuration of the eNB 200 will be described later.

The eNB 200 manages one or a plurality of cells, and performs radio communication with the UE 100 which establishes a connection with a cell of the eNB 200. The eNB 200 has a radio resource management (RRM) function, a routing function of user data, a measurement control function for mobility control and scheduling, and the like. The “cell” is used as a term indicating a smallest unit of a radio communication area, and is also used as a term indicating a function of performing radio communication with the UE 100.

The EPC 20 corresponds to a core network. A network of the LTE system is configured by the E-UTRAN 10 and the EPC 20. The EPC 20 includes an MME (Mobility Management Entity)/S-GW (Serving-Gateway) 300. The MME performs various types of mobility control and the like for the UE 100. The SGW performs transfer control of the user data. The MME/S-GW 300 is connected to the eNB 200 via an S1 interface.

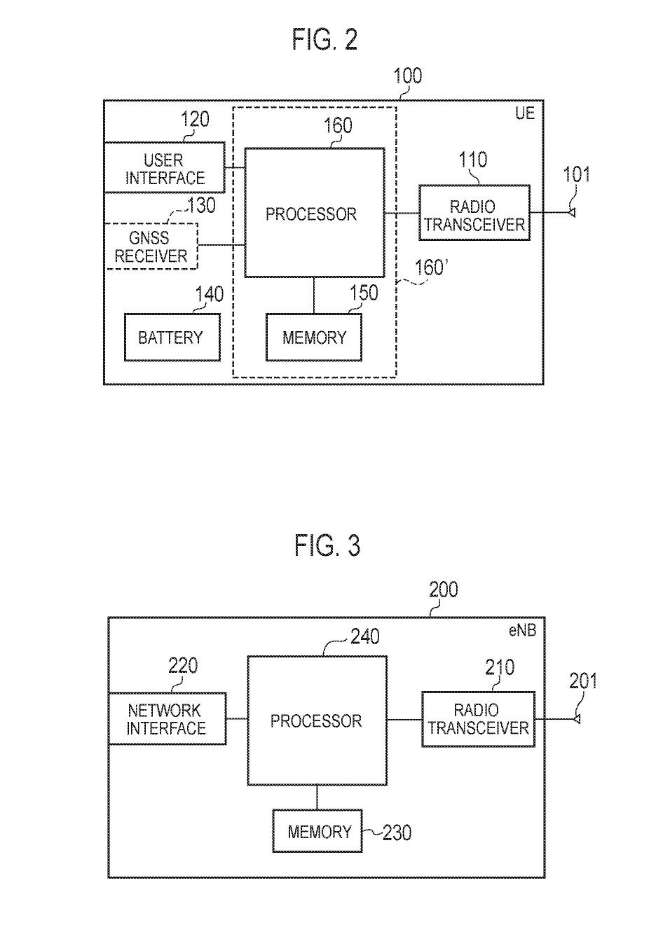

FIG. 2 is a block diagram of the UE 100. As shown in FIG. 2, the UE 100 includes a plurality of antennas 101, a radio transceiver 110, a user interface 120, a GNSS (Global Navigation Satellite System) receiver 130, a battery 140, a memory 150, and a processor 160. The memory 150 and the processor 160 configure a controller. The UE 100 may not have the GNSS receiver 130. Furthermore, the memory 150 may be integrally formed with the processor 160, and this set (that is, a chip set) may be called a processor 160′.

The plurality of antennas 101 and the radio transceiver 110 are used to transmit or receive a radio signal. The radio transceiver 110 converts a baseband signal (transmission signal) output from the processor 160 into a radio signal, and transmits the radio signal from the plurality of antennas 101. Furthermore, the radio transceiver 110 converts the radio signal received by the plurality of antennas 101 into a baseband signal (reception signal), and outputs the baseband signal to the processor 160.

The user interface 120 is an interface with a user carrying the UE 100, and includes a display, a microphone, a speaker, and various buttons. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, coding and decoding, and the like on the baseband signal, and a CPU (Central Processing Unit) that performs various types of processes by executing the program stored in the memory 150. The processor 160 may further include a codec that performs encoding and decoding on sound and video signals. The processor 160 executes various types of processes and various types of communication protocols described later.

FIG. 3 is a block diagram of the eNB 200. As shown in FIG. 3, the eNB 200 includes a plurality of antennas 201, a radio transceiver 210, a network interface 220, a memory 230, and a processor 240. The memory 230 and the processor 240 configure a controller.

The plurality of antennas 201 and the radio transceiver 210 are used to transmit or receive a radio signal. The radio transceiver 210 converts a baseband signal (transmission signal) output from the processor 240 into a radio signal, and transmits the radio signal from the plurality of antennas 201. Furthermore, the radio transceiver 210 converts the radio signal received by the plurality of antennas 201 into a baseband signal (reception signal), and outputs the baseband signal to the processor 240.

The network interface 220 is connected to a neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240. The processor 240 includes a baseband processor that performs modulation and demodulation, coding and decoding, and the like on the baseband signal, and a CPU that performs various types of processes by executing the program stored in the memory 230. The processor 240 executes various types of processes and various types of communication protocols described later.

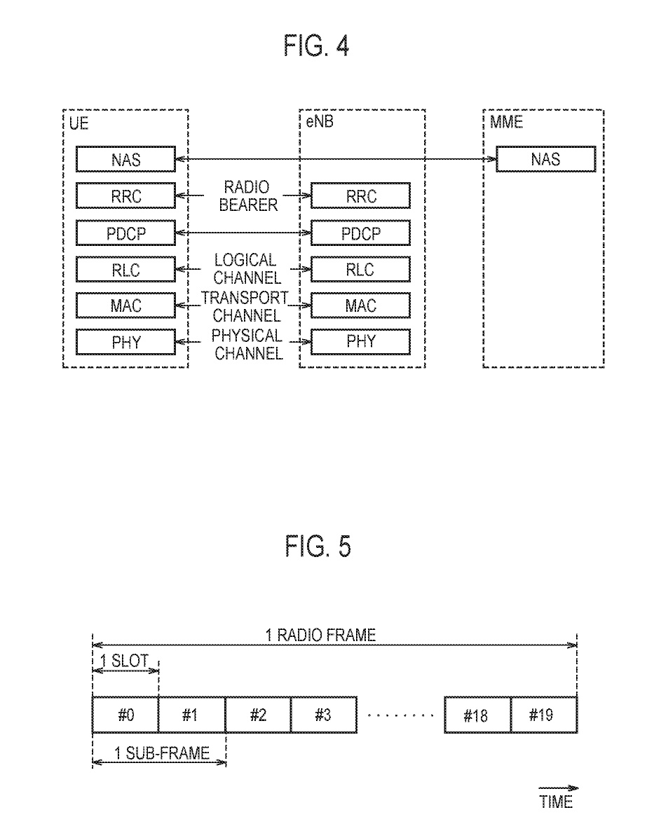

FIG. 4 is a protocol stack diagram of a radio interface in the LTE system. As shown in FIG. 4, the radio interface protocol is classified into a first layer to a third layer of an OSI reference model, such that the first layer is a physical (PHY) layer. The second layer includes a MAC (Medium Access Control) layer, an RLC (Radio Link Control) layer, and a PDCP (Packet Data Convergence Protocol) layer. The third layer includes an RRC (Radio Resource Control) layer.

The physical layer performs coding and decoding, modulation and demodulation, antenna mapping and demapping, and resource mapping and demapping. Between the physical layer of the UE 100 and the physical layer of the eNB 200, user data and control signals are sent via a physical channel.

The MAC layer performs priority control of data, and a retransmission process and the like by a hybrid ARQ (HARQ). Between the MAC layer of the UE 100 and the MAC layer of the eNB 200, user data and control signals are sent via a transport channel. The MAC layer of the eNB 200 includes a scheduler for deciding a transport format (a transport block size and a modulation and coding scheme) of an uplink and a downlink, and a resource block to be assigned to the UE 100.

The RLC layer sends data to an RLC layer of a reception side by using the functions of the MAC layer and the physical layer. Between the RLC layer of the UE 100 and the RLC layer of the eNB 200, user data and control signals are sent via a logical channel.

The PDCP layer performs header compression and decompression, and encryption and decryption.

The RRC layer is defined only in a control plane that handles control signals. Between the RRC layer of the UE 100 and the RRC layer of the eNB 200, a control signal (RRC message) for various types of settings is sent. The RRC layer controls the logical channel, the transport channel, and the physical channel according to the establishment, re-establishment, and release of a radio bearer. When a connection (RRC connection) is established between the RRC of the UE 100 and the RRC of the eNB 200, the UE 100 is in a connected state (RRC connected state), and when the connection is not established, the UE 100 is in an idle state (RRC idle state).

An NAS (Non-Access Stratum) layer positioned above the RRC layer performs session management, mobility management, and the like.

FIG. 5 is a configuration diagram of a radio frame used in the LTE system. In the LTE system, OFDMA (Orthogonal Frequency Division Multiple Access) is applied to a downlink (DL), and SC-FDMA (Single Carrier Frequency Division Multiple Access) is applied to an uplink (UL), respectively.

As shown in FIG. 5, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each of the resource blocks includes a plurality of subcarriers in the frequency direction. A resource element is configured by one subcarrier and one symbol.

Of the radio resources assigned to the UE 100, a frequency resource is configured by a resource block, and a time resource is configured by a subframe (or a slot).

In the DL, an interval of several symbols at the head of each subframe is a region used as a physical downlink control channel (PDCCH) for mainly sending the control signal. Furthermore, the remaining portion of each subframe is a region available as a physical downlink shared channel (PDSCH) for mainly sending user data.

In the UL, both ends in the frequency direction of each subframe are regions used as a physical uplink control channel (PUCCH) for mainly sending the control signal. The remaining portion in each subframe is a region available as a physical uplink shared channel (PUSCH) for mainly sending user data.

(D2D Communication)

The LTE system according to the embodiment supports D2D communication that is direct Device-to-Device communication (UE-to-UE communication). Here, the D2D communication is described in comparison with cellular communication that is normal communication of the LTE system. The cellular communication is a communication mode in which a data path passes through a network (E-UTRAN 10, EPC 20). The data path is a communication path for user data. On the other hand, the D2D communication is a communication mode in which a data path set between UEs does not pass through the network.

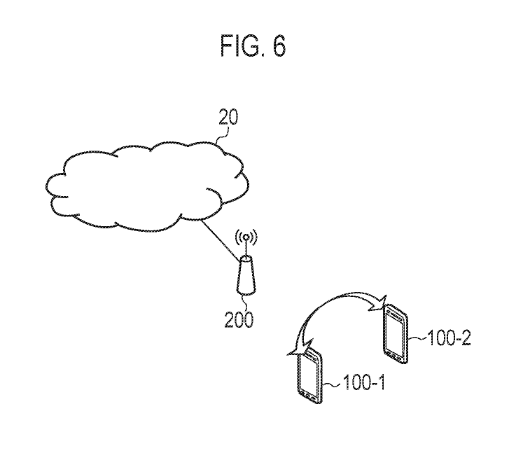

FIG. 6 is a diagram for describing the D2D communication. As shown in FIG. 6, in the D2D communication, a data path does not pass through the eNB 200. A UE 100-1 and a UE 100-2 adjacent to each other directly perform radio communication with low transmission power in a cell of the eNB 200. Thus, when the adjacent UE 100-1 and UE 100-2 directly perform radio communication with low transmission power, it is possible to reduce a power consumption of the UE 100 and to reduce interference to a neighboring cell, in comparison with in the cellular communication.

The UE 100 periodically transmits or receives a discovery signal used for discovering a nearby user terminal 100 to perform D2D communication. After such a discovery process, the UE 100 performs the D2D communication with a nearby UE 100. However, the UE 100 transmits or receives the discovery signal only in a predetermined period, and thus, even when there is a nearby UE 100 with which the D2D communication should be performed, it is difficult to promptly start the D2D communication. On the other hand, it may be possible to adopt a method in which a period during which the discovery signal is transmitted or received is previously set short; however, there is a problem that a consumption amount of radio resources to be used for transmitting or receiving the discovery signal increases, resulting in a lowered utilization efficiency of the radio resource.

(Operation According to Embodiment)

Next, an operation according to the embodiment will be described.

### (1) Operation Overview

The UE 100 according to the embodiment transmits or receives the discovery signal for the D2D communication. The UE 100 uses a first radio resource recognized by all the UEs 100 in a predetermined area of the mobile communication system (LTE system) to transmit or receive the periodical discovery signal. The “predetermined area” is a cell of the mobile communication system, for example. Alternatively, the “predetermined area” may be a service area of the mobile communication system.

In the embodiment, the eNB 200 performs control on the UE 100 that transmits or receives the periodical discovery signal by using the first radio resource. The eNB 200 notifies the UE 100 of a second radio resource for transmitting or receiving the non-periodical discovery signal between the UE 100 and a different UE 100 associated with the UE 100. The UE 100 uses the second radio resource to transmits or receive the non-periodical discovery signal.

When it is possible to transmit or receive such a non-periodical discovery signal, the UE 100 is capable of promptly start the D2D communication. Further, as compared to a method in which the period in the periodical discovery signal is previously set short, it is possible to improve the utilization efficiency of the radio resource. Therefore, it is possible to restrain lowering of the utilization efficiency of the radio resource and the UE 100 is capable of promptly starting the D2D communication.

“A different UE 100 associated with the UE 100” differs depending on each estimated scenario (operation pattern). In an operation pattern 1 according to the embodiment, out of the UE 100 and the different UE 100 associated with the UE 100, one UE 100 performs the D2D communication and another UE 100 is a UE 100 that desires to start the communication with the one UE 100.

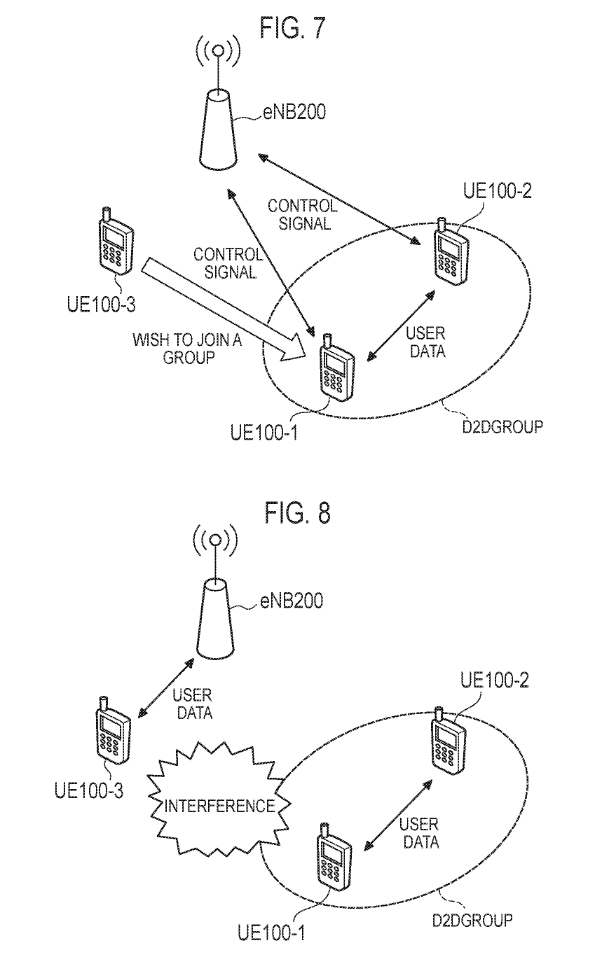

FIG. 7 is a diagram for describing the operation pattern 1. As shown in FIG. 7, in the cell of the eNB 200, the UE 100-1 to the UE 100-3 exist. The UE 100-1 and the UE 100-2 perform the D2D communication. The UE 100-1 and the UE 100-2 transmit or receive user data with each other, and transmit or receive a control signal to and from the eNB 200.

The UE 100-3 desires to start the communication with the UE 100-1. Specifically, the UE 100-3 is a UE 100 that desires to transmit the user data for the UE 100-1 or a UE 100 that desires to participate into the D2D communication performed by the UE 100-1.

In the operation pattern 1, the eNB 200 determines that the UE 100-3 that desires to start the communication with the UE 100-1 is near the UE 100-1. Then, the eNB 200 notifies the UE 100-1 and the UE 100-3 of the second radio resource for transmitting or receiving a non-periodical discovery signal. The UE 100-1 and the UE 100-3 use the second radio resource to transmit or receive the non-periodical discovery signal. This completes the discovery process between the UE 100-1 and the UE 100-3, and thus, it is possible to start the D2D communication between the UE 100-1 and the UE 100-3.

In an operation pattern 2 according to the embodiment, a different UE 100 associated with the UE 100 is a UE 100 that is determined to apply interference to the UE 100 and/or to receive interference from the UE 100.

FIG. 8 is a diagram for describing the operation pattern 2. As shown in FIG. 8, in the cell of the eNB 200, the UE 100-1 to the UE 100-3 exist. The UE 100-1 and the UE 100-2 perform the D2D communication. The UE 100-1 and the UE 100-2 transmit or receive user data with each other. In contrast, the UE 100-3 performs cellular communication. The UE 100-3 transmit or receives the user data to and from the eNB 200.

In the operation pattern 2, to enhance a utilization efficiency of a radio resource, at least a part of the radio resource available for D2D communication is secured to overlap the radio resource available for cellular communication. For example, the radio resource available for the D2D communication is at least a part of a radio resource available for an uplink of the cellular communication (uplink radio resource). Alternatively, the radio resource available for the D2D communication is at least a part of a radio resource available for a downlink of the cellular communication (downlink radio resource). In this case, the interference may occur between the D2D communication and the cellular communication.

In the operation pattern 2, the eNB 200 determines that the interference occurs between the UE 100-1 and the UE 100-3. Then, the eNB 200 notifies the UE 100-1 and the UE 100-3 of the second radio resource for transmitting or receiving a non-periodical discovery signal. Alternatively, the UE 100-1 or the UE 100-3 may determine the occurrence of the interference. The UE 100-1 and the UE 100-3 use the second radio resource to transmit or receive the non-periodical discovery signal. This completes the discovery process between the UE 100-1 and the UE 100-3, and thus, it is possible to start the D2D communication between the UE 100-1 and the UE 100-3. Therefore, it is possible to avoid the interference occurring between the D2D communication and the cellular communication.

In an operation pattern 3 according to the embodiment, a different UE 100 associated with the UE 100 is a UE 100 that performs the cellular communication with the UE 100.

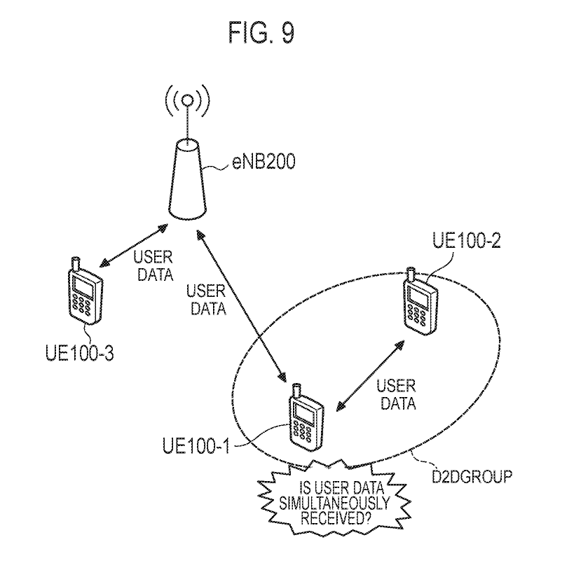

FIG. 9 is a diagram for describing the operation pattern 3. As shown in FIG. 9, in the cell of the eNB 200, the UE 100-1 to the UE 100-3 exist. The UE 100-1 and the UE 100-2 perform the D2D communication. The UE 100-1 and the UE 100-2 transmit or receive user data mutually. In contrast, the UE 100-3 performs cellular communication with the UE 100-1.

The UE 100-1 shares one radio transceiver 110 for the cellular communication and the D2D communication. A transmission power level handled in the cellular communication and the D2D communication differs, and thus, the UE 100 finds it difficult to simultaneously perform the cellular communication and the D2D communication by using one radio transceiver 110.

In the operation pattern 3, the eNB 200 determines that there is the UE 100-3 near the UE 100-1 that starts the cellular communication with the UE 100-3 during the D2D communication. Then, the eNB 200 notifies the UE 100-1 and the UE 100-3 of the second radio resource for transmitting or receiving a non-periodical discovery signal. The UE 100-1 and the UE 100-3 use the second radio resource to transmit or receive the non-periodical discovery signal. This completes the discovery process between the UE 100-1 and the UE 100-3, and thus, it is possible to start the D2D communication between the UE 100-1 and the UE 100-3. Therefore, it is possible to avoid a situation where the UE 100-1 simultaneously performs the cellular communication and the D2D communication.

It is noted that in the operation patterns 1 to 3, out of the UE 100-1 and the UE 100-3, the both may transmit the non-periodical discovery signal and the both may receive the non-periodical discovery signal, and in addition thereto, only either one may transmit the non-periodical discovery signal and only the other may receive the non-periodical discovery signal. For example, the UE 100-1 transmits the non-periodical discovery signal, and the UE 100-2 receives the non-periodical discovery signal. Alternatively, the UE 100-2 transmits the non-periodical discovery signal, and the UE 100-1 receives the non-periodical discovery signal. When only either one of the UE 100-1 and the UE 100-3 transmits the non-periodical discovery signal, the eNB 200 may also notify whether to transmit or receive the non-periodical discovery signal in notifying the second radio resource.

### (2) Specific Example

Next, a specific example of each of the above-described operation patterns 1 to 3 will be described.

(2.1) Operation Pattern 1

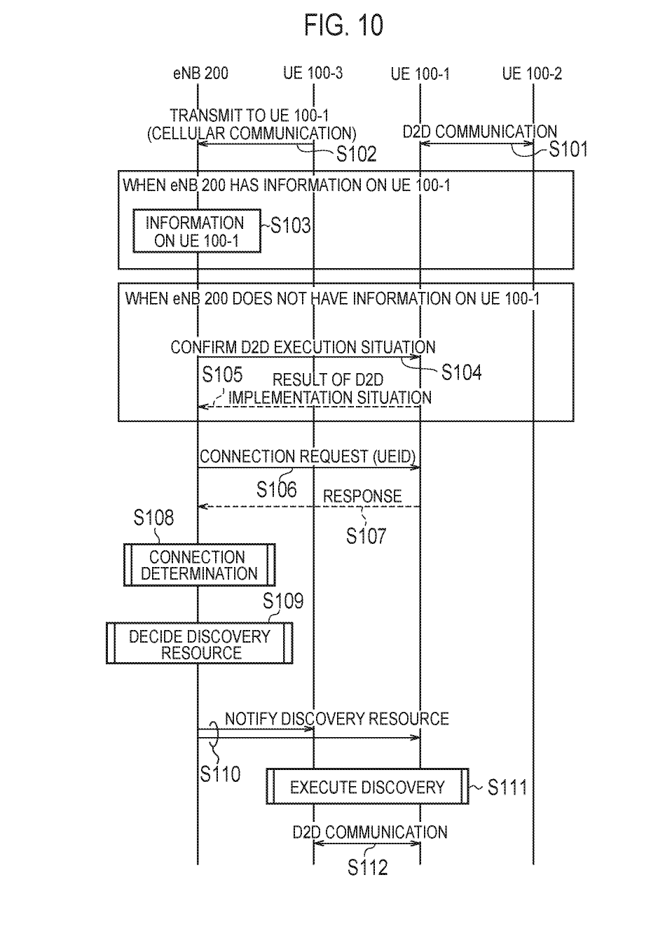

FIG. 10 is a sequence diagram of the operation pattern 1. In the operation pattern 1, it is assumed that the eNB 200 is capable of acquiring information on a distance between the UE 100-1 and the UE 100-3. The information on the distance between the UE 100-1 and the UE 100-3 includes a pathloss between the UE 100-1 and the UE 100-3 or location information of each of the UE 100-1 and the UE 100-3, for example.

As shown in FIG. 10, the UE 100-1 and the UE 100-2 perform the D2D communication (step S101). In step S102, the UE 100-3 transmits a communication request to the UE 100-1, to the eNB 200, by the cellular communication. The eNB 200 that receives the communication request to the UE 100-1 determines that the UE 100-3 desires to start the communication with the UE 100-1.

When having the information on the UE 100-1, the eNB 200 confirms the information on the UE 100-1 (step S103). On the other hand, when not having the information on the UE 100-1, the eNB 200 inquires the UE 100-1 of the information on the UE 100-1 to acquire the information (steps S104, S105).

In step S106, the eNB 200 request the UE 100-1 to perform a D2D communication connection with the UE 100-3. The UE 100-1 may return the response to the request from the eNB 200 (step S107). In step S108, the eNB 200 determines whether or not the D2D communication connection is possible between the UE 100-1 and the UE 100-3. For example, the eNB 200 determines on the basis of the pathloss information and the location information, for example, whether or not the UE 100-1 and the UE 100-3 are adjacent to each other so as to perform the D2D communication.

When it is determined that the D2D communication connection between the UE 100-1 and the UE 100-3 is possible, in step S109, the eNB 200 decides the second radio resource (Discovery resource) for transmitting or receiving the non-periodical discovery signal.

In step S110, the eNB 200 notifies the UE 100-1 and the UE 100-3 of the second radio resource. In step S111, the UE 100-1 and the UE 100-3 use the second radio resource to transmit or receive the non-periodical discovery signal, whereby the discovery process is succeeded. In step S112, the UE 100-1 and the UE 100-3 start the D2D communication.

In the present sequence, the eNB 200 receives from the UE 100-3 the communication request to the UE 100-1 to determine that the UE 100-3 desires to start the communication with the UE 100-1. However, the UE 100-3 may explicitly request the eNB 200 to start the D2D communication with the UE 100-1.

(2.2) Operation Pattern 2

In the operation pattern 2, when it is determined that the interference occurs between the UE 100-1 that performs the D2D communication and the UE 100-3 that performs the cellular communication, operations after step S108 in FIG. 10 are performed. For example, the UE 100-1 reports interference information on the interference from the cellular communication, to the eNB 200. Alternatively, the UE 100-3 reports interference information on the interference from the D2D communication, to the eNB 200. The eNB 200 determines on the basis of the reported interference information that there occurs the interference between the UE 100-1 that perform D2D communication and the UE 100-3 that performs the cellular communication.

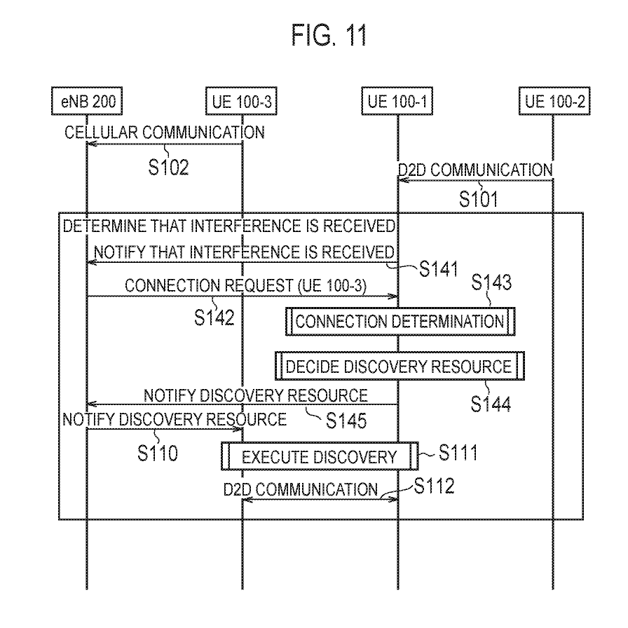

Alternatively, the determination of the interference may be performed by the UE 100-1 or the UE 100-3. FIG. 11 is a sequence diagram of a case where avoiding the interference is led by the UE 100 in the operation pattern 2. As shown in FIG. 11, the UE 100-1 and the UE 100-2 perform the D2D communication (step S101). Further, the UE 100-3 performs the cellular communication with the eNB 200 (step S102). In step S141, the UE 100-1 determines that the interference from the UE 100-3 is being received and notifies the eNB 200 of the interference being received. In step S142, the eNB 200 request the UE 100-1 to perform a D2D communication connection with the UE 100-3. The UE 100-1 may return the response to the request from the eNB 200.

In step S143, the UE 100-1 determines whether or not it is possible to perform the D2D communication connection with the UE 100-3. When it is determined that the D2D communication connection with the UE 100-3 is possible, in step S144, the UE 100-1 decides the second radio resource (Discovery resource) for transmitting or receiving the non-periodical discovery signal.

In step S145, the UE 100-1 notifies the eNB 200 of the second radio resource. The eNB 200 that is notified of the second radio resource notifies the UE 100-3 of the second radio resource. In step S111, the UE 100-1 and the UE 100-3 use the second radio resource to transmit or receive the non-periodical discovery signal, whereby the discovery process is succeeded. In step S112, the UE 100-1 and the UE 100-3 start the D2D communication.

(2.3) Operation Pattern 3

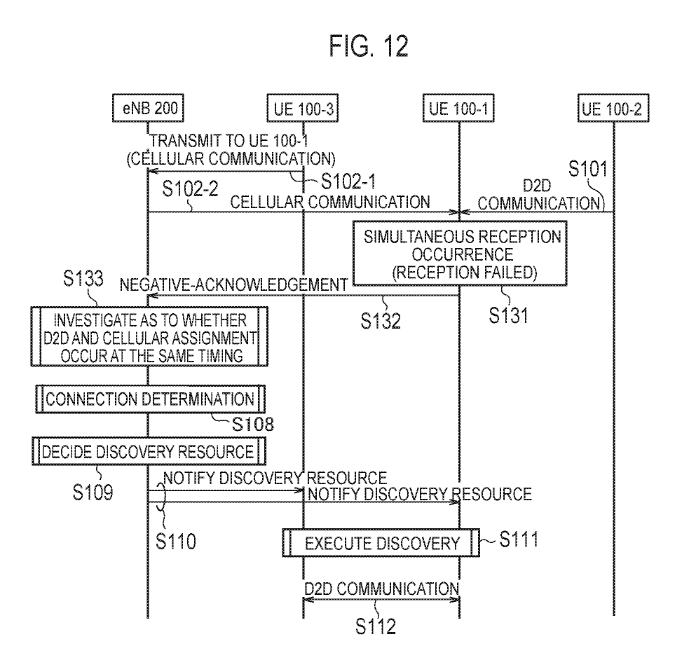

FIG. 12 is a sequence diagram of the operation pattern 3. In the operation pattern 3, it is assumed that the eNB 200 is capable of acquiring information on a distance between the UE 100-1 and the UE 100-3. The information on the distance between the UE 100-1 and the UE 100-3 includes a pathloss between the UE 100-1 and the UE 100-3 or location information of each of the UE 100-1 and the UE 100-3, for example.

As shown in FIG. 12, the UE 100-1 and the UE 100-2 perform the D2D communication (step S101). In step S102-1 and S102-2, the UE 100-3 starts the cellular communication with the UE 100-1 via a network.

In step S132, the UE 100-1 transmits to the eNB 200 a negative-acknowledgement (Nack) indicating that reception in the cellular communication and/or the D2D communication is failed.

In step S133, the eNB 200 that received the negative-acknowledgement (Nack) investigates whether the respective assignments of the D2D communication and the cellular communication to the UE 100-1 occur at the same timing. When the respective assignments of the D2D communication and the cellular communication to the UE 100-1 occur at the same timing, the eNB 200 determines whether or not the D2D communication connection with the UE 100-1 and the UE 100-3 is possible. For example, the eNB 200 determines on the basis of the pathloss information and the location information, for example, whether or not the UE 100-1 and the UE 100-3 are adjacent to each other so as to perform the D2D communication.

When it is determined that the D2D communication connection between the UE 100-1 and the UE 100-3 is possible, in step S109, the eNB 200 decides the second radio resource (Discovery resource) for transmitting or receiving the non-periodical discovery signal.

In step S110, the eNB 200 notifies the UE 100-1 and the UE 100-3 of the second radio resource. In step S111, the UE 100-1 and the UE 100-3 use the second radio resource to transmit or receive the non-periodical discovery signal, whereby the discovery process is succeeded. In step S112, the UE 100-1 and the UE 100-3 start the D2D communication.

It is noted that in the present sequence, the occurrence of the timing at which the D2D communication and the cellular communication are performed at the same time is determined in the eNB 200; however, the occurrence of a timing at which the D2D communication and the cellular communication are performed at the same time may be detected by the UE 100-1 and the eNB 200 may be notified thereof.

Further, the present sequence concerns may be applied to the simultaneous reception when the D2D communication is performed by utilizing the uplink radio resource, and may also applied to simultaneous transmission when the D2D communication is performed by utilizing the downlink radio resource.

### Summary of Embodiment

In the embodiment, the eNB 200 perform control on the UE 100 that transmits or receives the periodical discovery signal by using the first radio resource. The eNB 200 notifies the UE 100 of a second radio resource for transmitting or receiving the non-periodical discovery signal between the UE 100 and a different UE 100 associated with the UE 100. The UE 100 uses the second radio resource to transmit or receive the non-periodical discovery signal.

When it is possible to transmit or receive such a non-periodical discovery signal, the UE 100 is capable of promptly start the D2D communication. Further, as compared to a method in which the period in the periodical discovery signal is previously set short, it is possible to improve the utilization efficiency of the radio resource. Therefore, it is possible to restrain lowering of the utilization efficiency of the radio resource and the UE 100 is capable of promptly starting the D2D communication.

### First Modification of Embodiment

In the above-described embodiment, a case is assumed where the UE 100-1 to the UE 100-3 exist in the same cell; however, a part of the UE 100-1 to the UE 100-3 may exist in a different cell (neighboring cell, for example).

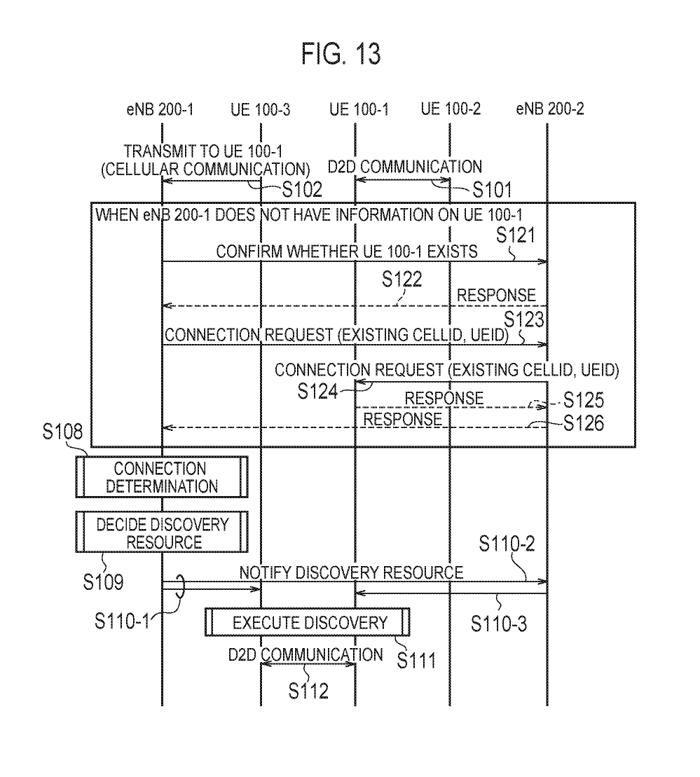

FIG. 13 is a sequence diagram according to a first modification of the embodiment. In FIG. 13, a part of the sequence of the operation pattern 1 according to the embodiment is modified. The UE 100-3 exists in the cell of the eNB 200-1. On the other hand, the UE 100-1 and the UE 100-2 exist in the cell of the eNB 200-2.

As shown in FIG. 13, the UE 100-1 and the UE 100-2 perform the D2D communication (step S101). In step S102, the UE 100-3 transmits a communication request to the UE 100-1, to the eNB 200-1, by the cellular communication. The eNB 200-1 that receives the communication request to the UE 100-1 determines that the UE 100-3 desires to start the communication with the UE 100-1.

When not having the information on the UE 100-1, the eNB 200-1 confirms the eNB 200-2 whether or not the UE 100-1 exists (step S121). The eNB 200-2 may return a response (step S122). The eNB 200-1 transmits a D2D communication connection request to the UE 100-1, to the eNB 200-2 (step S123). The eNB 200-2 transmits the D2D communication connection request received from the eNB 200-1, to the UE 100-1 (step S124). The UE 100-1 may return a response, via the eNB 200-2, to the UE 100-1 (steps S125, S126).

In step S108, the eNB 200-1 determines whether or not the D2D communication connection is possible between the UE 100-1 and the UE 100-3. For example, the eNB 200-1 determines on the basis of the pathloss information and the location information, for example, whether or not the UE 100-1 and the UE 100-3 are adjacent to each other so as to perform the D2D communication. When it is determined that the D2D communication connection between the UE 100-1 and the UE 100-3 is possible, in step S109, the eNB 200 decides the second radio resource (Discovery resource) for transmitting or receiving the non-periodical discovery signal. The eNB 200 notifies the UE 100-3 of the second radio resource (step S110-1) and notifies the eNB 200-2 of the second radio resource (step S110-2). The eNB 200-2 notifies the UE 100-1 of the second radio resource (step S110-3). In step S111, the UE 100-1 and the UE 100-3 use the second radio resource to transmit or receive the non-periodical discovery signal, whereby the discovery process is succeeded. In step S112, the UE 100-1 and the UE 100-3 start the D2D communication.

### Second Modification of Embodiment

In the above-described operation patterns 2 and 3, when the D2D communication connection is disabled between the UE 100-1 and the UE 100-3, the radio resource assigned to the UE 100-1 (data transmission-use radio resource) and the radio resource assigned to the UE 100-3 (data transmission-use radio resource) are differed ((hereinafter, referred to as “resource division”), whereby it is possible to resolve the problem of the interference and the problem of the simultaneous occurrence of the cellular and the D2D.

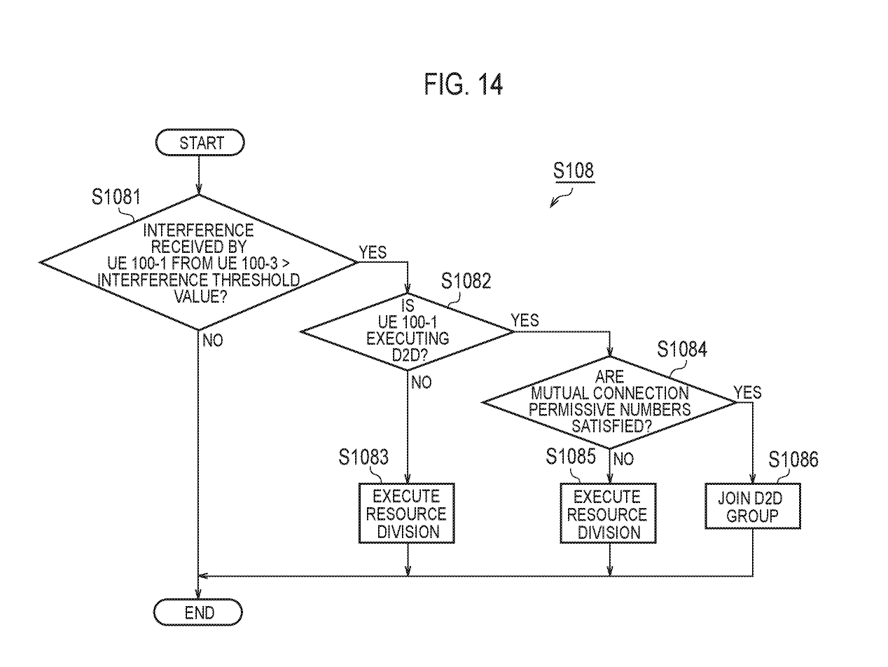

FIG. 14 is a flow diagram showing a connection determination operation according to a second modification of the embodiment. As shown in FIG. 14, in step S1081, the eNB 200 determines whether or not an interference level that UE 100-1 receives from the UE 100-3 is equal to or more than a threshold value. When “YES” in step S1081, in step S1082, the eNB 200-1 determines whether or not the UE 100-1 performs the D2D communication. When “No” in step S1082, in step S1083, the eNB 200-1 performs the resource division. When “Yes” in step S1082, in step S1084, the eNB 200-1 determines whether or not to satisfy a connection permissive number (that is, an upper limit number of radio connections that can be established) of each of the UE 100-1 and the UE 100-3. When “No” in step S1084, in step S1085, the eNB 200-1 performs the resource division. When “Yes” in step S1084, in step S1086, the eNB 200-1 notifies the UE 100-1 and the UE 100-3 of the second radio resource (Discovery resource).

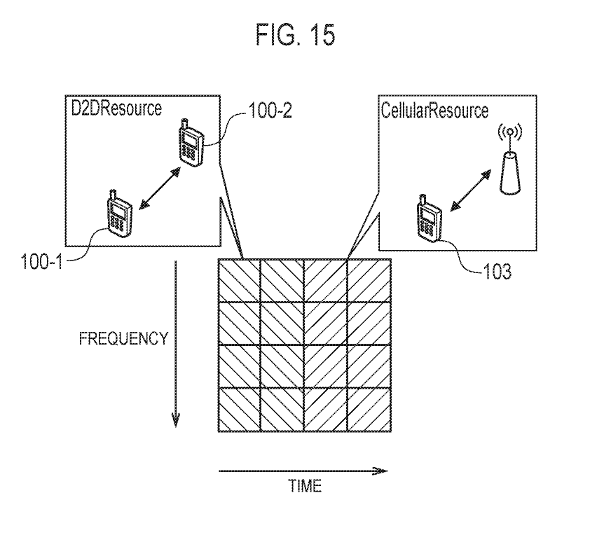

FIG. 15 is a diagram for describing the resource division. As shown in FIG. 15, the eNB 200-1 sets the radio resource assigned to the UE 100-1 (data transmission-use radio resource) and the radio resource assigned to the UE 100-3 (data transmission-use radio resource) in a time-division manner. A ratio of the time division may be set on the basis of a buffer amount, a pathloss, and channel information of each UE 100, for example. Further, the ratio of the time division may be updated periodically or on the basis of an event trigger.

### Other Embodiments

The operation patterns 1 to 3 according to the above-described embodiment may be performed separately and independently and may also be performed through a combination thereof.

In the above-described embodiment, the eNB 200 is described as a specific example of a network apparatus according to the present invention; however, the network apparatus according to the present invention may be the eNB 200 and an upper device (MME 300 or OAM, for example) of the eNB 200.

In each of the above-described embodiments, as one example of the cellular communication system, the LTE system is described; however, the present invention is not limited to the LTE system, and the present invention may be applied to systems other than the LTE system.

In addition, the entire content of Japanese Patent Application No. 2013-144027 (filed on Jul. 9, 2013) is incorporated in the present specification by reference.

### INDUSTRIAL APPLICABILITY

According to the present invention, it is possible to provide a user terminal, a network apparatus, and a processor, with which it is possible to restrain lowering of a utilization efficiency of a radio resource and promptly start D2D communication.

1. A user terminal that transmits or receives a discovery signal for D2D communication that is direct Device-to-Device communication, in a mobile communication system supporting the D2D communication, comprising:
a controller configured to transmit or receive a periodical discovery signal by using a first radio resource recognized by all user terminals in a predetermined area of the mobile communication system, wherein
the controller further transmits or receives a non-periodical discovery signal by using a second radio resource recognized by the user terminal and a different user terminal associated with the user terminal.

2. The user terminal according to claim 1, wherein
the second radio resource is notified from a network apparatus included in a network of the mobile communication system, and
the controller transmits or receives the non-periodical discovery signal by using the second radio resource notified from the network apparatus.

3. The user terminal according to claim 1, wherein
the different user terminal associated with the user terminal is a user terminal determined to be near the user terminal.

4. The user terminal according to claim 1, wherein
the different user terminal associated with the user terminal is a user terminal that performs cellular communication with the user terminal via a network of the mobile communication system.

5. The user terminal according to claim 1, wherein
the different user terminal associated with the user terminal is a user terminal determined to apply interference to the user terminal and/or to receive interference from the user terminal.

6. The user terminal according to claim 1, wherein
out of the user terminal and the different user terminal associated with the user terminal, one user terminal is a user terminal that performs the D2D communication and another user terminal is a user terminal that desires to start communication with the one user terminal.

7. A network apparatus included in a network of a mobile communication system supporting D2D communication that is direct Device-to-Device communication, comprising:
a controller configured to perform control on a user terminal that transmits or receives a periodical discovery signal by using a first radio resource recognized by all user terminals in a predetermined area of the mobile communication system, wherein
the controller notifies the user terminal of a second radio resource for transmitting or receiving a non-periodical discovery signal between the user terminal and a different user terminal associated with the user terminal.

8. The network apparatus according to claim 7, wherein
the different user terminal associated with the user terminal is a user terminal determined to be near the user terminal.

9. The network apparatus according to claim 7, wherein
the different user terminal associated with the user terminal is a user terminal that performs cellular communication with the user terminal via the network.

10. The network apparatus according to claim 7, wherein
the different user terminal associated with the user terminal is a user terminal determined to apply interference to the user terminal and/or to receive interference from the user terminal.

11. The network apparatus according to claim 7, wherein
out of the user terminal and the different user terminal associated with the user terminal, one user terminal is a user terminal that performs the D2D communication and another user terminal is a user terminal that desires to start communication with the one user terminal.

12. The network apparatus according to claim 7, wherein
when it is determined that performing the D2D communication between the user terminal and the different user terminal associated with the user terminal is disabled, the controller controls so that a data transmission-use radio resource assigned to the user terminal and a data transmission-use radio resource assigned to the different user terminal associated with the user terminal are differed.

13. A processor for controlling a user terminal that transmits or receives a discovery signal for discovering other user terminal in its proximity, wherein the processor executes:
a process of transmitting or receiving a periodical discovery signal by using a first radio resource recognized by all user terminals in a predetermined area of the mobile communication system; and
a process of transmitting or receiving a non-periodical discovery signal by using a second radio resource recognized by the user terminal and a different user terminal associated with the user terminal.

14. A user terminal capable of transmitting or receiving a discovery signal for discovering other user terminal in its proximity, comprising:
a controller configured to transmit or receive a periodical discovery signal by using a first radio resource recognized by all user terminals in a predetermined area, wherein
the controller transmits or receives a non-periodical discovery signal by using a second radio resource recognized by the user terminal and a different user terminal associated with the user terminal.
